(19) United States
(12) Patent Application Publication
(10) Pub. No.: US 2009/0197018 A1
(43) Pub. Date: Aug. 6, 2009

(54) LIQUID CRYSTAL DISPLAY DEVICE

(76) Inventors: Midori TSUKANE, Kanazawa-shi (JP); Hirofumi Wakemoto, Kanazawa-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/364,735

(22) Filed: Feb. 3, 2009

(30) Foreign Application Priority Data
Feb. 6, 2008 (JP) 2008-026715

(51) Int. Cl. G02F 1/13; C09K 19/00

(52) U.S. Cl. 428/1.3

(57) ABSTRACT

A liquid crystal layer is formed of a liquid crystal composition including at least one of a compound A which includes a compound of two 6-membered rings in a main skeleton, one of the 6-membered rings being a benzene ring and the other of the 6-membered rings being a cyclohexane ring, and which is expressed by a general formula (1),

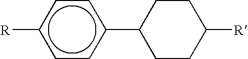

and a compound B in which both of the two 6-membered rings are cyclohexane rings, and which is expressed by a general formula (2),

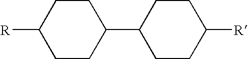

(each of R and R′ represents an alkyl group or an alkenyl group with a carbon atom number of 2 to 5, and a case in which R and R′ are identical is included).

### CROSS-REFERENCE TO RELATED APPLICATIONS

This application is based upon and claims the benefit of priority from prior Japanese Patent Application No. 2008-026715, filed Feb. 6, 2008, the entire contents of which are incorporated herein by reference.

### BACKGROUND OF THE INVENTION

1. Field of the Invention

The present invention relates generally to a liquid crystal display device, and more particularly to a liquid crystal display device using an optically compensated bend (OCB) alignment technique.

2. Description of the Related Art

Liquid crystal display devices have widely been applied to various technical fields by virtue of their features such as light weight, small thickness and low power consumption. The liquid crystal display device is configured such that a liquid crystal layer is held between a pair of substrates. An image is displayed by controlling the modulation ratio of light, which passes through the liquid crystal layer, by an electric field between a pixel electrode and a counter-electrode.

There has been proposed a liquid crystal composition containing a compound, as disclosed in Jpn. Pat. Appln. KOKAI Publication No. 2002-226859, for instance, thereby to meet the demand for a liquid crystal material with relatively small dielectric constant anisotropy Δ∈ and viscosity and large refractive index anisotropy Δn in the liquid crystal display device of a twisted nematic (TN) mode or a super-twisted nematic (STN) mode.

In recent years, attention has been paid to a liquid crystal display device to which an OCB mode is applied, as a liquid crystal display device which can improve a viewing angle and a response speed. The OCB mode liquid crystal display device is configured such that a liquid crystal layer including liquid crystal molecules, which are bend-aligned in a state in which a predetermined voltage is applied, is held between a pair of substrates. Compared to the TN mode, the OCB mode is advantageous in that the response speed can be increased and the viewing angle can be increased since the effect of birefringence of light, which passes through the liquid crystal layer, can be optically self-compensated by the alignment state of liquid crystal molecules.

In the OCB mode liquid crystal display device, it is preferable to apply a liquid crystal material having large refractive index anisotropy Δn from the viewpoint of optical compensation, and having large dielectric constant anisotropy Δ∈ from the viewpoint of driving. Hence, as a result, in many cases, a liquid crystal material with a very high viscosity is applied.

Of all physical property values of the liquid crystal material, the viscosity is most influential upon the response time. In addition, the temperature dependency of viscosity is very great, and there is a tendency that the viscosity exponentially increases on the low-temperature side, in particular. Consequently, even if the OCB mode, which can increase the response speed, is adopted as the mode, the response time becomes slow and there is a concern that the advantage of the OCB mode cannot be obtained.

### BRIEF SUMMARY OF THE INVENTION

The object of the present invention is to provide a liquid crystal display device having a high responsivity over a wide temperature range.

According to an aspect of the invention, there is provided a liquid crystal display device which is configured such that a liquid crystal layer is held between a pair of substrates and an OCB mode is applied, the liquid crystal layer being formed of a liquid crystal composition including at least one of a compound A which includes a compound of two 6-membered rings in a main skeleton, one of the 6-membered rings being a benzene ring and the other of the 6-membered rings being a cyclohexane ring, and which is expressed by a general formula (1),

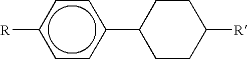

(each of R and R′ represents an alkyl group or an alkenyl group with a carbon atom number of 2 to 5, and a case in which R and R′ are identical is included), and a compound B in which both of the two 6-membered rings are cyclohexane rings, and which is expressed by a general formula (2),

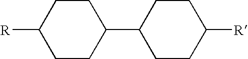

(each of R and R′ represents an alkyl group or an alkenyl group with a carbon atom number of 2 to 5, and a case in which R and R′ are identical is included).

The present invention can provide a liquid crystal display device having a high responsivity over a wide temperature range.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows the structure of a liquid crystal display device according to an embodiment of the present invention;

FIG. 2 is a cross-sectional view that schematically shows the structure of an OCB mode liquid crystal display panel which is applicable to the liquid crystal display device shown in FIG. 1;

FIG. 3 is a graph showing the relationship between a viscosity γ₁ of a liquid crystal composition at minus 20° C. and a response time;

FIG. 4 is a graph showing the relationship between the content ratio (wt %) of a bicyclic compound in a liquid crystal composition and the viscosity γ₁ of the liquid crystal composition at minus 20° C.; and

FIG. 5 is a graph showing the relationship between the content ratio (wt %) of a compound B of a bicyclohexane skeleton in a liquid crystal composition and the viscosity γ₁ of the liquid crystal composition at minus 20° C.

### DETAILED DESCRIPTION OF THE INVENTION

A liquid crystal display device according to an embodiment of the present invention will now be described with reference to the accompanying drawings. Liquid crystal display devices are generally classified into a transmissive liquid crystal display device in which one pixel is composed of only a transmissive part which displays an image by selectively passing backlight, a reflective liquid crystal display device in which one pixel is composed of only a reflective part which displays an image by selectively reflecting ambient light (or front light emitted from a front light unit), and a transflective liquid crystal display device in which one pixel includes both the reflective part and the transmissive part. All of these types of liquid crystal display devices fall within the scope of the present invention. In the present embodiment, a transmissive liquid crystal display device, to which an OCB mode is applied, is described by way of example.

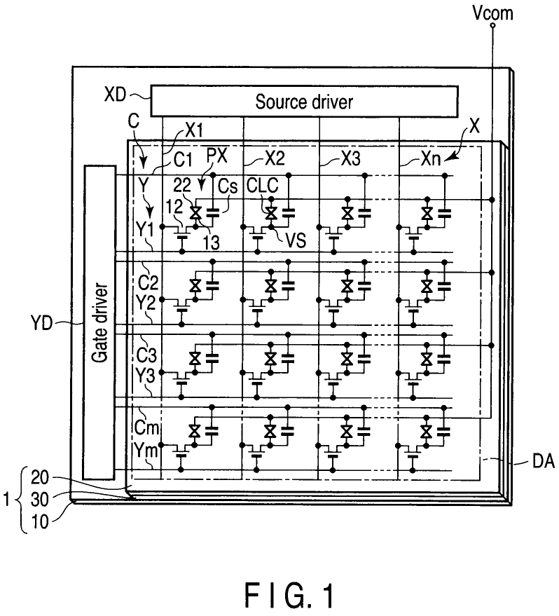

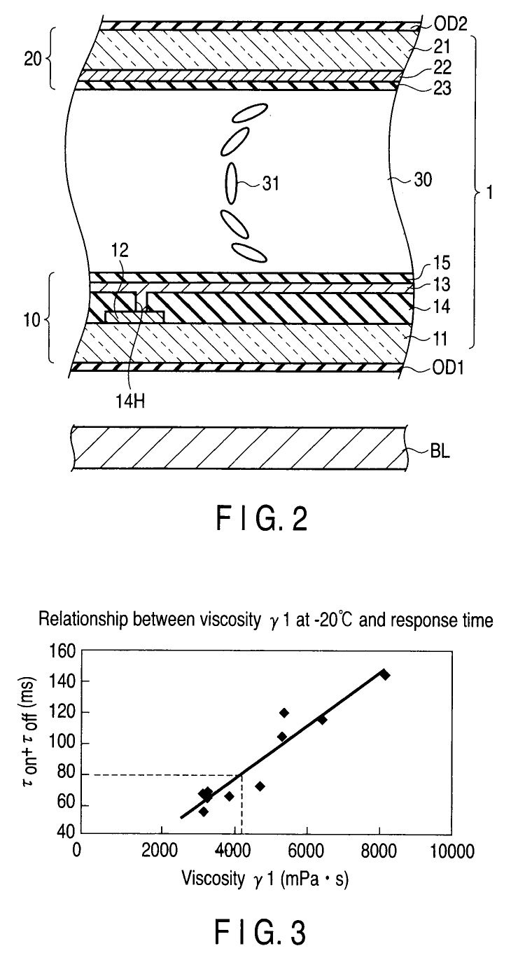

As is shown in FIG. 1 and FIG. 2, the transmissive liquid crystal display device includes a liquid crystal display panel 1 to which an OCB mode is applied, a backlight BL which illuminates the liquid crystal display panel 1, a first optical compensation element OD1 which is disposed between the liquid crystal display panel 1 and the backlight BL, and a second optical compensation element OD2 which is disposed on an observation surface side of the liquid crystal display panel 1.

The liquid crystal display panel 1 is configured such that a liquid crystal layer 30 is held between a pair of substrates, namely, an array substrate (first substrate) 10 and a counter-substrate (second substrate) 20. The liquid crystal display panel 1 has an active area DA which displays an image. The active area DA is composed of a plurality of pixels PX which are arranged in a matrix.

The array substrate 10 is formed by using a light-transmissive insulating substrate 11 such as a glass substrate. The array substrate 10 includes, on one major surface of the insulating substrate 11 (i.e. the surface opposed to the liquid crystal layer 30), signal supply lines for supplying various signals which are necessary for driving the respective pixels PX.

Specifically, the array substrate 10 includes, as the signal supply lines, a plurality of scanning lines Y (Y1 to Ym) and a plurality of storage capacitance lines C (C1 to CM), which extend in a row direction of the pixels PX; an N-number of signal lines X (X1 to Xn) which extend in a column direction of the pixels PX; and switching elements 12 which are disposed in the respective pixels PX. Further, the array substrate 10 includes pixel electrodes 13 which are connected to the switching elements 12. Each of the scanning lines Y is connected to a gate driver YD which supplies driving signals (scanning signals). Each of the signal lines X is connected to a source driver XD which supplies driving signals (video signals).

The switching elements 12 are composed of, e.g. thin-film transistors (TFTs). The switching elements 12 are disposed at intersection parts between the scanning lines Y and signal lines X in association with the respective pixels PX. The gate of the switching element 12 is electrically connected to the associated scanning line Y (or formed integral with the scanning line Y). The source of the switching element 12 is electrically connected to the associated signal line X (or formed integral with the signal line X). The drain of the switching element 12 is electrically connected to the associated pixel electrode 13.

The pixel electrode 13 is disposed on an insulation film 14 which covers the switching element 12, and is electrically connected to the drain of the switching element 12 via a contact hole 14H which is formed in the insulation film 14. In the case of a transmissive liquid crystal display device, the pixel electrode 13 is formed of a light-transmissive electrically conductive material such as indium tin oxide (ITO) or indium zinc oxide (IZO). In the case of a reflective liquid crystal display device, the pixel electrode 13 is formed of a light-reflective electrically conductive material such as aluminum (Al).

The surface of the pixel electrode 13 (i.e. that surface of the array substrate 10, which is in contact with the liquid crystal layer 30), is covered with a first alignment film 15 for controlling the alignment of liquid crystal molecules 31 included in the liquid crystal layer 30.

The counter-substrate 20 is formed by using a light-transmissive insulating substrate 21 such as a glass substrate. The counter-substrate 20 includes, on one major surface of the insulating substrate 21 (i.e. the surface opposed to the liquid crystal layer 30), a counter-electrode 22 which is disposed to be opposed to the pixel electrodes 13 of the plural pixels PX. The counter-electrode 22 is formed of a light-transmissive electrically conductive material such as ITO.

The surface of the counter-electrode 22 (i.e. that surface of the counter-substrate 20, which is in contact with the liquid crystal layer 30), is covered with a second alignment film 23 for controlling the alignment of the liquid crystal molecules included in the liquid crystal layer 30.

The array substrate 10 and counter-substrate 20 having the above-described structures are disposed in the state in which the pixel electrodes 13 are opposed to the counter-electrode 22, and a predetermined cell gap is provided between the array substrate 10 and counter-substrate 20 via spacers (e.g. columnar spacers formed integral with one of the substrates). The array substrate 10 and counter-substrate 20 are attached by a sealant SE which is so disposed as to surround the active area DA. The liquid crystal layer 30 is formed of a liquid crystal composition which is sealed in the cell gap between the array substrate 10 and counter-substrate 20.

The liquid crystal layer 30 is formed of a liquid crystal composition including the liquid crystal molecules 31 which have positive dielectric constant anisotropy and optically positive uniaxiality. In the liquid crystal layer 30, the liquid crystal molecules 31 are bend-aligned between the array substrate 10 and counter-substrate 20, as shown in FIG. 2, in a predetermined display state in which a predetermined voltage (transition voltage) is applied to the liquid crystal layer 30.

In a color display type liquid crystal display device, the liquid crystal display panel 1 includes, in the active area DA, a plurality of kinds of pixels, for instance, a red pixel that displays red (R), a green pixel that displays green (G), and a blue pixel that displays blue (B). Specifically, the red pixel includes a red color filter that passes light with a principal wavelength of red. The green pixel includes a green color filter that passes light with a principal wavelength of green. The blue pixel includes a blue color filter that passes light with a principal wavelength of blue. These color filters are disposed on the major surface of the array substrate 10 or the counter-substrate 20.

Each of the pixels PX has a liquid crystal capacitance CLC between the associated pixel electrode 13 and the counter-electrode 22. A plurality of storage capacitance lines C(C1 to Cm) are capacitive-coupled to the pixel electrodes 13 of the associated rows, thus constituting storage capacitances Cs.

The first optical compensation element OD1 and second optical compensation element OD2 have functions of optically compensating retardation of the liquid crystal layer 30 in a predetermined display state in which a voltage is applied to the liquid crystal layer 30 in the above-described liquid crystal display panel 1. Each of the first optical compensation element OD1 and second optical compensation element OD2 is configured to include a polarizer and a retardation plate. The first optical compensation element OD1 is disposed on the other major surface (i.e. the surface opposed to the backlight BL) of the insulating substrate 11 which constitutes the array substrate 10. The second optical compensation element OD2 is disposed on the other major surface (i.e. the surface on the observation side) of the insulating substrate 21 which constitutes the counter-substrate 20.

In this OCB mode liquid crystal display panel 1, the first alignment film 15 and second alignment film 23, which hold the liquid crystal layer 30, are subjected to rubbing treatment in mutually parallel directions. By the functions of the alignment films, the liquid crystal molecules 31 included in the liquid crystal layer 30 are splay-aligned at a stage prior to power-on. The splay alignment corresponds to a state in which the liquid crystal molecules 31 are positioned substantially horizontal (i.e. the liquid crystal molecules 31 are substantially parallel to the major surface of the substrate).

After power-on, an initializing process is executed at a stage prior to a display operation. In the initializing process, a transition voltage is applied to the liquid crystal layer 30. The alignment state of the liquid crystal molecules 31 is transitioned from the splay alignment to the bend alignment by a relative strong electric field corresponding to the transition voltage. During the display operation, the alignment state of the liquid crystal molecules 31 is kept in the bend alignment.

In the display operation, when a white display voltage for displaying a white image (an image at a gray level corresponding to a highest luminance) is applied to the liquid crystal layer 30, the liquid crystal molecules 31 in a mid-plane of the liquid crystal layer 30 are erected substantially perpendicular to the substrate, while the liquid crystal molecules 31 near the substrate are disposed substantially horizontal. On the other hand, when a black display voltage for displaying a black image (an image at a gray level corresponding to a lowest luminance) is applied to the liquid crystal layer 30, the liquid crystal molecules 31 near the substrate, as well as the liquid crystal molecules 31 in the mid-plane of the liquid crystal layer 30, are erected substantially perpendicular to the substrate.

In the OCB mode liquid crystal display panel 1, the alignment state of the liquid crystal molecules 31 reversely transitions from the bend alignment to the splay alignment in the case where a voltage at a level lower than an antagonistic level between the energy of splay alignment and the energy of bend alignment is applied, or in the case where a voltage non-application state continues for a long time.

Thus, in order to prevent this reverse transition, a black insertion driving method is adopted in the OCB mode liquid crystal display panel 1. In the black insertion driving, for example, a reverse transition prevention voltage and a voltage corresponding to a video signal are alternately applied to the liquid crystal layer 30 as driving voltages in every frame cycle, thus maintaining the bend alignment. In the normally white mode, since the reverse transition prevention voltage corresponds to the black display voltage, this driving method is called “black insertion driving”.

In the meantime, a response time z of the liquid crystal composition, of which the liquid crystal layer 30 is formed, is theoretically expressed by the following equations:

τₒₙ=γ₁·d²/(∈₀·|Δ∈|·(Vₒₙ²−Vₜₕ²))

τ_{off}=γ₁·d²/(π²·K)

where τₒₙ is a response time (rising time) when a driving voltage Vₒₙ is applied to the pixel electrode, and τ_{off} is a response time (falling time) when the voltage is turned off. In the equations, γ₁ is viscosity, d is a cell gap, ∈₀ is a dielectric constant in vacuum, Vth is a threshold voltage, and K is an elastic constant.

As is clear from the above theoretical equations, the response time τ becomes longer in proportion to the viscosity γ₁. Thus, there has been a demand for the advent of a liquid crystal composition of the OCB mode liquid crystal layer 30, which meets the conditions of the refractive index anisotropy Δn and dielectric constant anisotropy Δ∈ and has a low viscosity. In particular, with an increasing demand for uses in portable terminal devices and vehicles, there has been a demand for securing a sufficiently quick response time in a low-temperature (e.g. minus 20° C.) environment, as well as in a room-temperature environment at about 20° C.

FIG. 3 shows the relationship between the viscosity γ₁ of the liquid crystal composition at minus 20° C. and the response time (τₒₙ+τ_{off}). It is understood that in order to realize a response time of 80 ms or less, which is tolerable as a response time in motion video display, the viscosity γ₁ needs to be set at about 4500 mPa·s or less.

The inventor has paid attention to the fact that the viscosity of a liquid crystal composition including a compound, in which a cyclohexane ring is introduced, decreases.

In the present embodiment, the liquid crystal layer 30 is formed of a liquid crystal composition including at least one of a compound A which includes a compound of two 6-membered rings in a main skeleton, one of the 6-membered rings being a benzene ring and the other of the 6-membered rings being a cyclohexane ring, and which is expressed by a general formula (1)

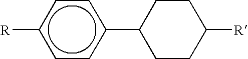

(each of R and R′ represents an alkyl group or an alkenyl group with a carbon atom number of 2 to 5, and a case in which R and R′ are identical is included), and a compound B which has a bicyclohexane skeleton, in which both of the two 6-membered rings are cyclohexane rings, and which is expressed by a general formula (2)

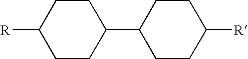

(each of R and R′ represents an alkyl group or an alkenyl group with a carbon atom number of 2 to 5, and a case in which R and R′ are identical is included).

In the theoretical equations of the response time τ, the dielectric constant anisotropy Δ∈ and elastic constant K, which are liquid crystal physical property values, also have temperature dependency, but the temperature dependency of the viscosity γ₁ is so large that the value of viscosity γ₁ may vary by an order of magnitude. As a result, since the contribution ratio of the viscosity γ₁ to the response time τ increases in the low-temperature environment, it is necessary to apply a material which can minimize the viscosity γ₁.

The above-described liquid crystal composition including at least one of the compound A expressed by the general formula (1) and the compound B expressed by the general formula (2) can suppress an increase in the viscosity γ₁ even in the low-temperature environment, and, as a result, it is possible to provide an OCB mode liquid crystal display device having high responsivity not only in the room-temperature or high-temperature environment but also in the low-temperature environment.

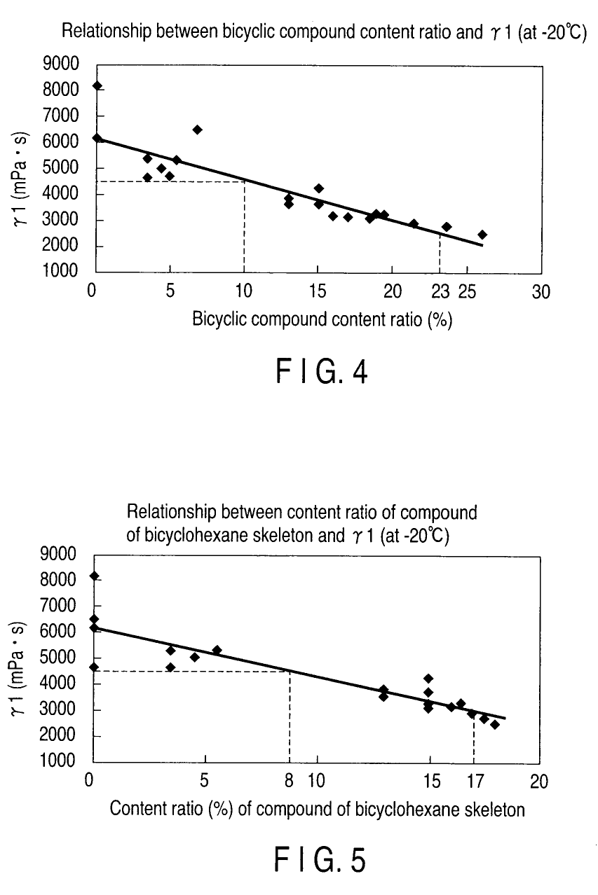

The relationship between the content ratio (wt %) of the compound A and compound B in the liquid crystal composition and the viscosity γ₁ of the liquid crystal composition at minus 20° C. was measured. FIG. 4 shows the result of measurement. It was found that the viscosity γ₁ can be set at 4500 mPa·s or less in the low-temperature environment of minus 20° C. by setting the content ratio of the bicyclic compound, in which at least one of two 6-membered rings included in the main skeleton is a cyclohexane ring, at 10 wt % or more. Thereby, even in the low-temperature environment, the response time can be set at 80 ms or less.

On the other hand, in the OCB mode, there is a tendency that the driving voltage increases with respect to a liquid crystal composition having an extremely low viscosity γ₁. In particular, if the content ratio of the bicyclic compound exceeds 23 wt %, the dielectric constant anisotropy Δ∈ becomes too small and the driving voltage increases, and a problem of breakdown voltage may undesirably arise. It is thus preferable that the content ratio of the bicyclic compound in the liquid crystal composition be less than 23 wt %. As described above, the content ratio of the bicyclic compound in the liquid crystal composition should preferably be set in the range of 10 wt % to 23 wt %.

Paying attention to the content ratio (wt %) of the compound B in the liquid crystal composition, the relationship between the content ratio (wt %) of the compound B and the viscosity γ₁ of the liquid crystal composition at minus 20° C. was measured. FIG. 5 shows the result of measurement. It was found that the viscosity γ₁ can be set at 4500 nPa·s or less in the low-temperature environment of minus 20° C. by setting the content ratio of the compound B, in which the main skeleton is a bicyclohexane skeleton, at 8 wt % or more. Thereby, even in the low-temperature environment, the response time can be set at 80 ms or less.

On the other hand, if the content ratio of the compound B exceeds 17 wt %, the dielectric constant anisotropy Δ∈ becomes too small and the driving voltage increases, and a problem of breakdown voltage may undesirably arise. It is thus preferable that the content ratio of the compound B in the liquid crystal composition be less than 17 wt %. As described above, the content ratio of the compound B in the liquid crystal composition should preferably be set in the range of 8 wt % to 17 wt %.

Since the volatility of the above-described compound A and compound B is high, it is highly possible that the content ratio of the compound A and compound B decreases when the liquid crystal composition is injected in the cell gap in a vacuum. It is thus desirable to control the degree of vacuum and to set the content ratio of the compound A and compound B in the liquid crystal composition before injection at a relatively high level, so that the content ratio of the compound A and compound B in the liquid crystal layer may become a predetermined value even if the compound A and compound B are evaporated. It is also preferable to use a dispenser method in which the liquid crystal composition can be injected at a relatively low degree of vacuum. In the liquid crystal display panel 1 to which the dispenser method is applied, an injection port for injecting the liquid crystal composition is needless. Specifically, the sealant SE for attaching the array substrate 10 and counter-substrate 20 is disposed in a loop shape surrounding the active area DA.

The present invention is not limited directly to the above-described embodiment. In practice, the structural elements can be modified and embodied without departing from the spirit of the invention. Various inventions can be made by properly combining the structural elements disclosed in the embodiment. For example, some structural elements may be omitted from all the structural elements disclosed in the embodiment. Furthermore, structural elements in different embodiments may properly be combined.

What is claimed is:

1. A liquid crystal display device which is configured such that a liquid crystal layer is held between a pair of substrates and an OCB mode is applied, the liquid crystal layer being formed of a liquid crystal composition including at least one of a compound A which includes a compound of two 6-membered rings in a main skeleton, one of the 6-membered rings being a benzene ring and the other of the 6-membered rings being a cyclohexane ring, and which is expressed by a general formula (1), 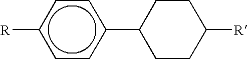
(each of R and R′ represents an alkyl group or an alkenyl group with a carbon atom number of 2 to 5, and a case in which R and R′ are identical is included), and a compound B in which both of the two 6-membered rings are cyclohexane rings, and which is expressed by a general formula (2), 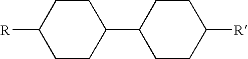
(each of R and R′ represents an alkyl group or an alkenyl group with a carbon atom number of 2 to 5, and a case in which R and R′ are identical is included).

2. The liquid crystal display device according to claim 1, wherein in the liquid crystal layer, a content ratio of the compound A expressed by the general formula (1) and the compound B expressed by the general formula (2) is 10 wt % or more.

3. The liquid crystal display device according to claim 2, wherein in the liquid crystal layer, the content ratio of the compound A expressed by the general formula (1) and the compound B expressed by the general formula (2) is less than 23 wt %.

4. The liquid crystal display device according to claim 1, wherein in the liquid crystal layer, a content ratio of the compound B expressed by the general formula (2) is 8 wt % or more.

5. The liquid crystal display device according to claim 4, wherein in the liquid crystal layer, the content ratio of the compound B expressed by the general formula (2) is less than 17 wt %.

6. The liquid crystal display device according to claim 1, wherein the pair of substrates are attached by a sealant which is disposed in a loop shape.
